(19) United States
(12) Patent Application Publication
(10) Pub. No.: US 2013/0032230 A1
(43) Pub. Date: Feb. 7, 2013

(54) FLOW DISTRIBUTOR

(71) Applicants: Klaus Olesen, Soenderborg (DK); Lars Paulsen, Hollingstedt (DE); Andre Daniel, Kropp (DE); Frank Osterwald, Kiel (DE)

(72) Inventors: Klaus Olesen, Soenderborg (DK); Lars Paulsen, Hollingstedt (DE); Andre Daniel, Kropp (DE); Frank Osterwald, Kiel (DE)

(73) Assignee: Danfoss Silicon Power GmbH, Schleswig (DE)

(21) Appl. No.: 13/640,581

(22) PCT Filed: Apr. 8, 2011
(86) PCT No.: PCT/DK2011/000025

§ 371 Date: Oct. 11, 2012

(30) Foreign Application Priority Data
Apr. 13, 2010 (DK) PA 2010 00307

(51) Int. Cl. F16L 41/00

(52) U.S. Cl. 137/561 A

(57) ABSTRACT

A flow distributor for distributing a flow of fluid through a cooling body, the flow distributor comprising:
an inlet manifold;
an outlet manifold; and
one or more flow cells, each being arranged to fluidly interconnect the inlet manifold and the outlet manifold, each flow cell comprising a cell inlet in fluid communication with the inlet manifold, a cell outlet in fluid communication with the outlet manifold, and a flow channel for guiding a flow of fluid from the cell inlet to the cell outlet,
   wherein the flow distributor is formed within a solid layer which is bonded directly to an insulating layer to be cooled.

### CROSS REFERENCE TO RELATED APPLICATIONS

This application is entitled to the benefit of and incorporates by reference essential subject matter disclosed in International Patent Application No. PCT/DK2011/000025 filed on Apr. 8, 2011 and Danish Patent Application No. PA 2010 00307 filed Apr. 13, 2010.

### FIELD OF THE INVENTION

The present invention relates to a flow distributor distributing coolant. In particular the present invention relates to a flow distribution module which provides more efficient and economic cooling that prior art distributors.

### BACKGROUND OF THE INVENTION

Power semiconductors are often mounted on substrates comprising an electrically insulating layer with a metal layer on each side. Power semiconductors may be mounted on a first side of the insulating layer with a first metal layer acting as a circuit to connect the various terminals of the semiconductors. Heat is generated by the semiconductors when they are in service, and this heat passes through the first metal layer, through the insulating layer and then through a second metal layer attached to the opposite side of the insulating layer. Heat can then be transported away from the semiconductors by use of, for example, a coolant which is in contact with the second metal layer. Whilst this can be sufficient in many applications, in some situations it is an advantage if the coolant can be transported as close as possible to the insulating layer in order to reduce the thermal path length and thus increase the rate of heat transfer away from the semiconductor.

It has been proposed that fluid flow channels be formed in the second metal layer and coolant can then be made to pass closer to the insulating layer. This solution has the disadvantage that traditionally the thickness of the metal layer was restricted to around a millimetre at most, resulting in very narrow channels with resulting increase in flow resistance and reduction in flow. Such channels were also liable to blockage and the resultant lowering in reliability.

A modification of the above solution is to build up a thick metal layer comprising several thin layers, each layer comprising a pattern of holes which, when assembled, formed a set of flow channels suitable for transporting coolant. Whilst an improvement, this solution still only allowed the formation of relatively narrow channels, with the above disadvantages. In addition the assembling of several metal layers is an expensive process, leading to a distinct commercial disadvantage of the known method.

### SUMMARY OF THE INVENTION

It is an object of the invention to provide a flow distributor which is capable of providing more even cooling than known technology.

It is an additional object of the invention to provide a flow distributor which is capable of providing an improved cooling efficiency as compared to prior art flow distributors.

It is a further object of the invention to provide a flow distributor providing an improved heat transfer while maintaining a low pressure drop across the flow distributor.

It is an even further object of the invention to provide a flow distributor which is simpler and cheaper to manufacture than known flow distributors.

According to the invention the above and other objects are fulfilled by providing a flow distributor for distributing a flow of fluid through a cooling body, the flow distributor comprising:
an inlet manifold,
an outlet manifold,
one or more flow cells, each being arranged to fluidly interconnect the inlet manifold and the outlet manifold, each flow cell comprising a cell inlet in fluid communication with the inlet manifold, a cell outlet in fluid communication with the outlet manifold, and a flow channel for guiding a flow of fluid from the cell inlet to the cell outlet,
wherein the flow distributor is formed within a solid layer which is bonded directly to an insulating layer to be cooled.

The solid layer may be formed from the same material as the insulating layer, or it may be formed from a different material.

Such a flow distributor facilitates more even cooling of the insulating layer by virtue of the fact that each flow cell cools a small portion of the insulating layer and is supplied with coolant directly from the inlet manifold and discharges directly to the outlet manifold.

Additionally, since the flow distributor is formed directly within the solid layer there is a very short thermal path length from the insulating layer to be cooled to the coolant. The cooling efficiency of the flow distributor is therefore extremely high.

The method of bonding directly to the insulating layer may be by molten bonding, eutectic bonding or by other suitable method.

The fluid is preferably a liquid, but it may alternatively be a gas or a mixture of gas and liquid.

The flow distributor comprises an inlet manifold, an outlet manifold and one or more flow cells. The flow cells are each arranged to fluidly interconnect the inlet manifold and the outlet manifold. Thus, fluid is guided from the inlet manifold to the outlet manifold via one or more flow cells. The inlet manifold distributes fluid to the flow cells, and fluid from the flow cells is collected in the outlet manifold. The inlet manifold may advantageously be fluidly connected to a fluid source providing cold fluid. Similarly, the outlet manifold may advantageously be fluidly connected to a fluid drain for collecting fluid which has been guided through the flow cells. The fluid may be recirculated, in which case a heat exchanger may advantageously be arranged between the outlet manifold and the inlet manifold in order to avoid an increase in temperature of the fluid being guided through the flow cells.

The insulating layer may have a thickness that is a compromise between ease of handling during manufacture and ease of transmission of heat generated by heat generating components that may be mounted on the side of the insulating layer remote from the flow distributor. In one embodiment the thickness of the insulating layer is 0.38 mm, such as between 0.2 mm and 0.5 mm, such as between 0.1 mm and 1 mm, such as between 0.01 mm and 10 mm.

The insulating layer may comprise a ceramic. Examples of suitable ceramics include silicon nitride, aluminium nitride and alumina.

The inlet manifold, the outlet manifold and the one or more flow cells may formed by die casting. Such a method is inexpensive compared with other methods of forming channels in solids, and therefore the flow distributor made in this manner is simpler and cheaper to produce than other comparable products.

The solid layer may comprise a metal such as aluminium or an aluminium alloy or a suitable plastic material.

The thickness of the flow distributor is at least 0.5 mm, and may be 50 mm or more thick. Such a thickness enables the flow distributor to comprise wide passages thus providing an improved heat transfer while maintaining a low pressure drop across the flow distributor.

When a surface is cooled by guiding a laminar flow of fluid, such as a flow of liquid along the surface, a boundary layer is normally formed in the flowing fluid immediately adjacent to the surface. In the boundary layer the flow velocity is lower than the flow velocity of the remaining part of the cooling fluid. The thickness of the boundary layer increases along the flow direction of the fluid, and the combination of the increasing thickness of the boundary layer and the lower flow velocity causes the heat transfer, and thereby the cooling efficiency, of the system to decrease, in some cases drastically.

At least one flow cell may be so formed as to cause the fluid to repeatedly change direction when flowing from the cell inlet to the cell outlet. Such changes in flow direction as a fluid flows from the inlet manifold to the outlet manifold via the flow path cause disturbances of the flow pattern, thereby contributing to preventing formation of a boundary layer.

In addition, the inventive flow distributor may be adapted to be connected to another at least substantially identical flow distributor in such a manner that the inlet manifold is connected to another at least substantially identical inlet manifold to form a common fluid inlet, and in such a manner that the outlet manifold is connected to another at least substantially identical outlet manifold to form a common fluid outlet, the flow distributor thereby being adapted to form part of a stack of flow distributors.

The inventive flow distributor may be adapted for different coolants such as water, oil, gas or even two-phase coolants where appropriate.

### BRIEF DESCRIPTION OF THE DRAWINGS

The invention will now be described in further detail with reference to the accompanying drawings in which

FIG. 1 is a perspective view of a flow distributor according to a first embodiment of the invention,

FIG. 2 is a perspective view of the same embodiment as FIG. 1,

FIG. 3 is a perspective view of the metal layer of the first embodiment of the current invention,

FIG. 4 shows the flow distributor in an assembled form,

FIG. 6 illustrates a perspective view of a second embodiment of the invention,

FIG. 7 illustrates yet another embodiment,

FIG. 8 illustrates a perspective view of a further embodiment of the invention,

FIG. 9 is a perspective view of the component side of the embodiment shown in FIG. 8 and

FIG. 10 is a perspective view of ten of the embodiments shown in FIGS. 8 and 9 assembled to form a stack of flow distributors.

### DETAILED DESCRIPTION

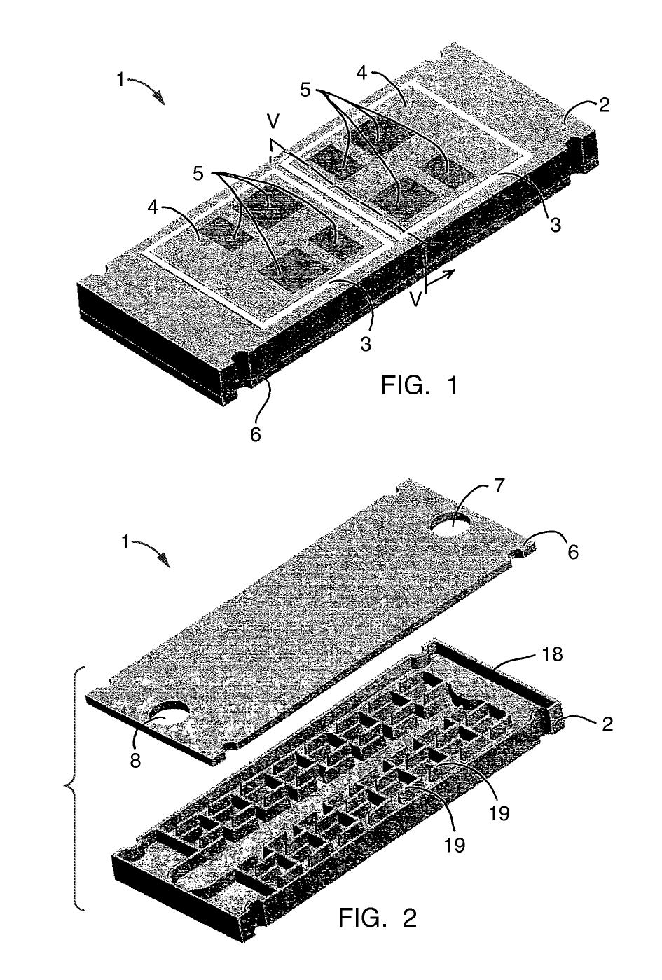

FIG. 1. is a perspective view of a flow distributor 1 according to a first embodiment of the invention. The flow distributor 1 comprises a aluminium layer 2 upon one surface of which is bonded two ceramic layers 3. On the side away from the aluminium layer 2 both ceramic layers are attached to a further aluminium layer 4 on which are attached a number of power semiconductor components 5. Such power semiconductor components 5, when in service, produce heat which is conducted through the aluminium layer 4, the ceramic layer 3 and to the metal layer 2. The metal layer 2 is of a thickness of 10 mm, although it may be of other thicknesses.

FIG. 2. is a perspective view of the same embodiment as FIG. 1, but this time the flow distributor 1 is viewed from the other direction, the ceramic layers 3 are not visible in this view, being on the opposite side of the distributor 1. What is visible in this figure, however, is the metal layer 2 and its internal structure. This structure comprises an outer wall 18 and several internal wall segments 19 dividing the area within the outer wall into spaces which become enclosed volumes when the plate 6 is placed over the outer wall 18. The internal structure will be more fully described below. Plate 6 is shown here in an ‘exploded’ position to allow the details of the internal structure of the metal layer 2 to be seen. Also visible here are two holes in the plate 6, the inlet 7 and outlet 8, through which coolant enters and leaves the distributor 1 respectively. The plate 6 is formed from aluminium or aluminium alloy, and is connected to the metal layer 2 when in position by brazing or welding. The plate 6 adds increased bending stiffness and pressure robustness to the completed design of flow distributor 1.

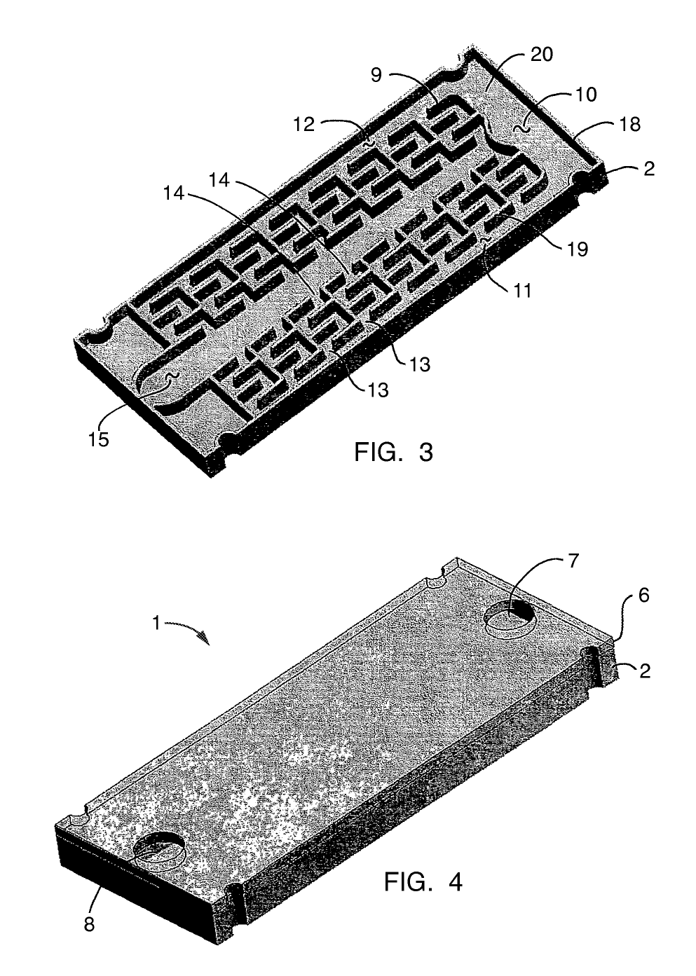

FIG. 3 is a perspective view of the metal layer 2 of the first embodiment of the current invention. In this view, drawn at a slightly different angle to those of FIGS. 1 and 2 in order that the internal details are more visible. The metal layer 2 is formed by a die casting process. The metal layer 2 comprises a flat base plate 20 on the face adjacent to the ceramic layer 3 (not visible) from which walls extend in a direction away from the ceramic layer 3. These walls define the structure that guides coolant from the inlet 7 to the outlet 8. The thickness of the flat base plate 20 may be substantially less than the height of the walls 18 and 19. It is a distinct advantage for it to be then, since it will then form a shorter thermal path from the ceramic layer 3 to the coolant. The thickness of the flat base plate 20 can in fact be zero, where the areas between the walls extend as far as the surface of the ceramic layer 3 itself, and allowing the coolant to contact directly the ceramic layer and thus greatly enhancing the transfer of heat.

Coolant entering through the inlet 7 will be first received in the inlet manifold 10. From there it will travel through one of two side passages 11, 12 in fluid connection with the inlet manifold 10 and from there through one of sixteen flow cells each having an cell inlet 13 and an cell outlet 14 and which all deliver coolant from the cell inlet 13 to the cell outlet 14 via a meandering passage defined by the cell walls. All cell outlets are in fluid connection with the outlet manifold 15 which is in turn in fluid connection with the outlet 8.

It will be clearly understood that in moving from the inlet manifold 10 to the outlet manifold 15 the coolant will remove heat from the heat generating power semiconductors 5 mounted on the opposite side of the metal layer 2. It will also be apparent that the coolant will pass through only one flow cell in passing from the inlet manifold 10 to the outlet manifold 15. As a corollary, it will be seen that each flow cell obtains coolant directly from the inlet manifold 10, and thus the cooling effect will be maximised.

FIG. 4 shows the flow distributor 1 in an assembled form, the plate 6 having been attached to the metal layer 2.

FIG. 5 shows a combined perspective and cross sectional view along the plane V-V in FIG. 1. Portions of the inlet manifold 11, 12 and the outlet manifold 15 are visible.

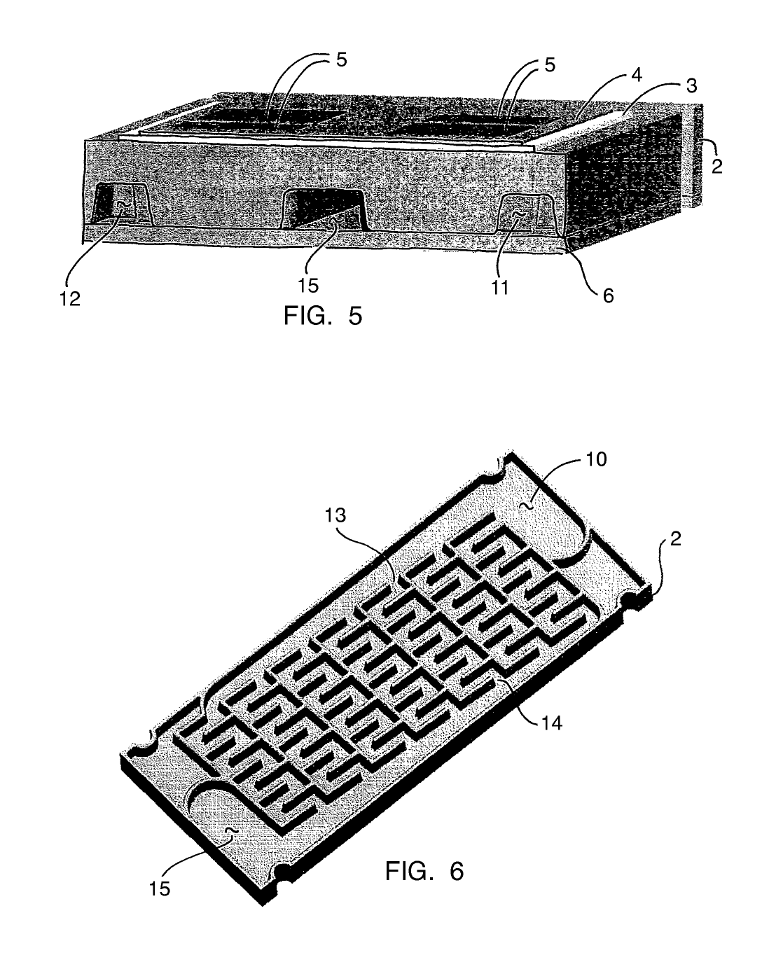

FIG. 6 illustrates a perspective view of a second embodiment of the invention. This embodiment is identical with the first embodiment with the exception of the pattern of flow cells. Here there are only 7 flow cells, each with an inlet 13 and an outlet 14.

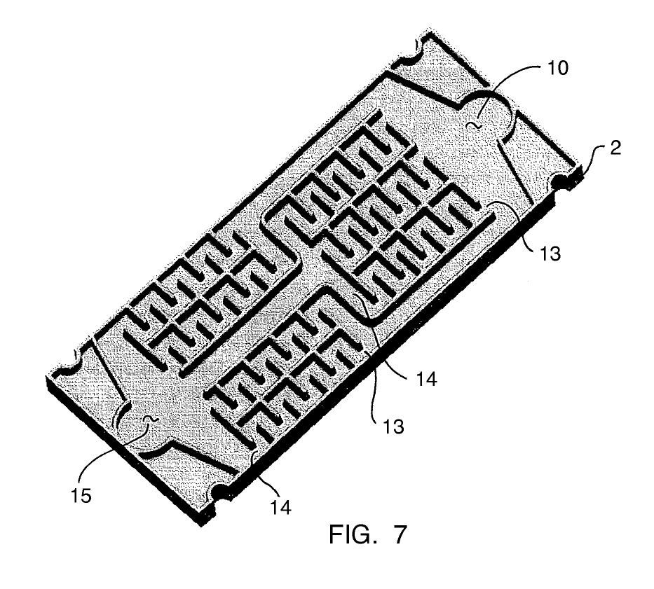

FIG. 7 illustrates yet another embodiment. Here there are seven flow cells again. The different flow cell patterns are designed to remove heat from specific configurations of power semiconductor components 5 on the reverse side of the metal layer 2.

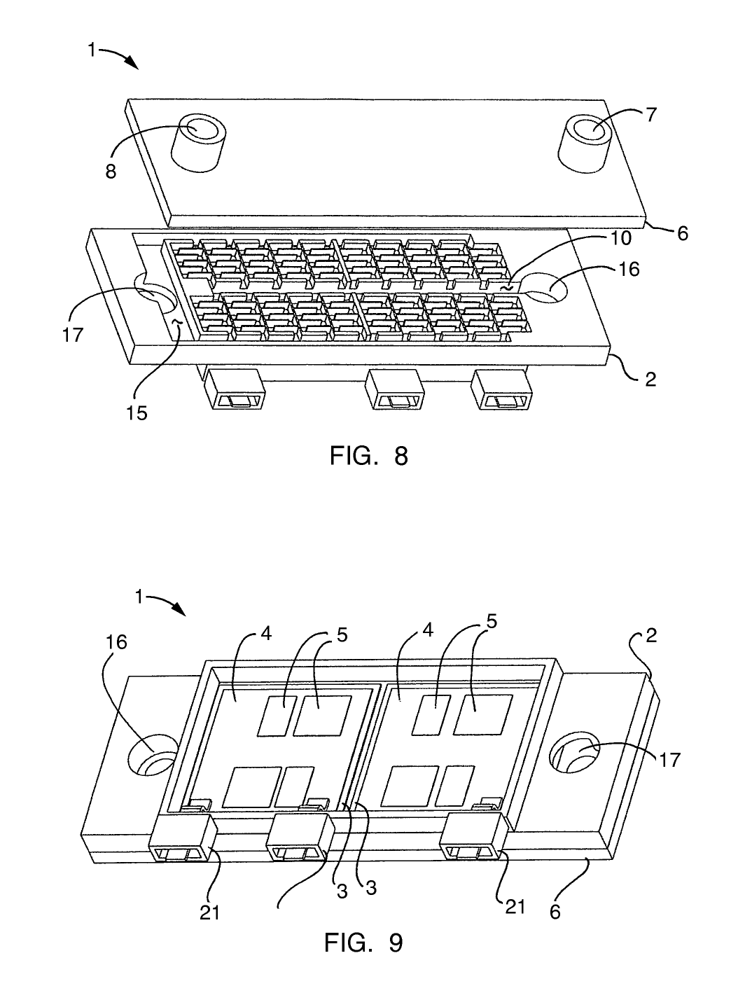

FIG. 8 illustrates a perspective view of a further embodiment of the invention. This embodiment is adapted to be connected to another at least substantially identical flow distributor 1 in such a manner that the inlet manifold 10 is connected to another at least substantially identical inlet manifold 10 to form a common fluid inlet, and in such a manner that the outlet manifold 15 is connected to another at least substantially identical outlet manifold 15 to form a common fluid outlet, the flow distributor 1 thereby being adapted to form part of a stack of flow distributors. To enable this to happen a second opening 16 is made in the inlet manifold 10 and a similar additional opening 17 is made in the outlet manifold 15. When the flow distributors 1 are stacked, these openings are in fluid communication with each other and thus form the common fluid inlets and outlets.

FIG. 9 is a perspective view of the component side of the embodiment shown in FIG. 8. Connectors 21 are electrical connectors to the circuitry associated with the power semiconductors 5.

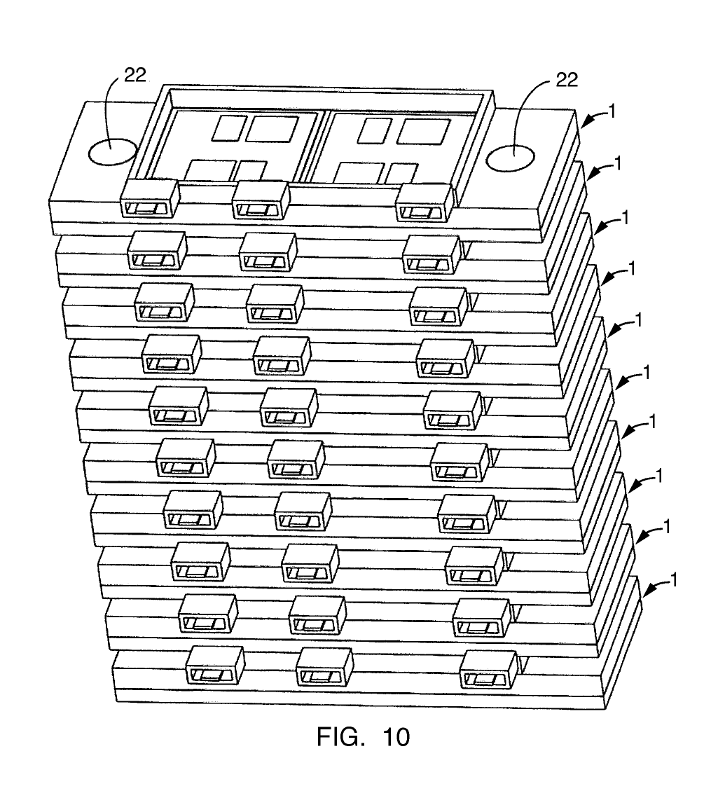

FIG. 10 is a perspective view of ten of the embodiments shown in FIGS. 8 and 9 assembled to form a stack of flow distributors. Here stoppers 22 are placed in the unused inlet and outlet on the top flow distributor to seal off the inlet and outlet manifolds. Coolant is brought into the system via an inlet at the opposite end of the stack (not shown) and leaves from an equivalent outlet.

The embodiments described above have been for the structure and use of a flow distributer for cooling a insulating layer and by that means the cooling of power semiconductor components. The invention is not restricted to being used to extract heat from a object, since, as will be clear to those well versed in the art of heat transfer, that the same technology may also be used to add heat to an object.

Although various embodiments of the present invention have been described and shown, the invention is not restricted thereto, but may also be embodied in other ways within the scope of the subject-matter defined in the following claims.

What is claimed is:

1-11. (canceled)

12. A flow distributor for distributing a flow of fluid through a cooling body, the flow distributor comprising:
an inlet manifold;
an outlet manifold; and
one or more flow cells, each being arranged to fluidly interconnect the inlet manifold and the outlet manifold, each flow cell comprising a cell inlet in fluid communication with the inlet manifold, a cell outlet in fluid communication with the outlet manifold, and a flow channel for guiding a flow of fluid from the cell inlet to the cell outlet,
wherein the flow distributor is formed within a solid metal layer which is bonded directly to an insulating layer to be cooled, and in that an aluminium layer is attached to the insulating layer on the side away from the metal layer, a number of power semiconductor components being attached to the aluminium layer.

13. The flow distributor according to claim 12 wherein the thickness of the insulating layer is 0.38 mm, such as between 0.2 mm and 0.5 mm, such as between 0.1 mm and 1 mm, such as between 0.01 mm and 10 mm.

14. The flow distributor according to claim 12 wherein the insulating layer comprises a ceramic.

15. The flow distributor according to claim 12 wherein the inlet manifold, the outlet manifold and the one or more flow cells are formed by die casting.

16. The flow distributor according to claim 12 wherein the metal is aluminium or an aluminium alloy.

17. The flow distributor according to claim 12 wherein the thickness of the flow distributor is at least 0.5 mm.

18. The flow distributor according to claim 12 wherein at least one flow cell is so formed as to cause the fluid to repeatedly change direction when flowing from the cell inlet to the cell outlet.

19. The flow distributor according to claim 12 which is adapted to be connected to another at least substantially identical flow distributor in such a manner that the inlet manifold is connected to another at least substantially identical inlet manifold to form a common fluid inlet, and in such a manner that the outlet manifold is connected to another at least substantially identical outlet manifold to form a common fluid outlet, the flow distributor thereby being adapted to form part of a stack of flow distributors.

20. The flow distributor according to claim 13 wherein the insulating layer comprises a ceramic.
